(19) United States
(12) Patent Application Publication
(10) Pub. No.: US 2019/0269200 A1
(43) Pub. Date: Sep. 5, 2019

(54) MAT STRUCTURE AND SOLE STRUCTURE

(71) Applicants: Yi-Chen TSENG, Taichung City (TW); HI-MAX INNOVATION CO., LTD., Taichung City (TW)

(72) Inventor: Yi-Chen TSENG, Taichung City (TW)

(73) Assignees: Yi-Chen Tseng; Hi-Max Innovation Co., Ltd.

(21) Appl. No.: 16/414,463

(22) Filed: May 16, 2019

Related U.S. Application Data
(63) Continuation-in-part of application No. 15/266,749, filed on Sep. 15, 2016.

(51) Int. Cl. A43B 13/18; A43B 13/12; A43B 13/04; B32B 7/022; B32B 3/28; B32B 3/30; B32B 5/18; B32B 25/04; B32B 25/08; A43B 13/22

(52) U.S. Cl. CPC A43B 13/187; B32B 2266/0221; A43B 13/04; B32B 7/022; B32B 3/28; B32B 3/30; B32B 5/18; B32B 25/045; B32B 25/08; A43B 13/22; B32B 2437/02; B32B 2307/51; B32B 2307/744; B32B 2471/04; A43B 13/127

(57) ABSTRACT

A sole structure includes: an anti-skid layer, a rigid layer, an elastic piece and a soft layer which are superimposed upon one another. With the characteristic of the elastic piece being elastically deformable, a rebounding force can be produced to act on the foot to stimulate the ligaments and muscles of the foot, which consequently corrects the flatfoot.

### CROSS REFERENCE TO RELATED APPLICATION

This application is a continuation in part of U.S. patent application Ser. No. 15/266,749, which claims the earlier filing date of Sep. 15, 2016, the entire specification of which is incorporated herein by reference.

### BACKGROUND OF THE INVENTION

### Field of the Invention

The present invention relates to a foot stimulating structure, and more particularly to a mat structure. The present invention further relates to a sole structure.

### Related Prior Art

Flatfoot is a condition in which the arch of the foot has flattened out, and generally includes pseudo flatfoot, flexible flatfoot and rigid flatfoot. Among them, the pseudo flatfoot is common in toddlers due to the fatty of the foot hides the arch formation, and the arch of the foot will gradually be visible as the toddlers grow up.

Flexible flatfoot is the most common flatfoot and caused by ligament laxity. Therefore, a lot of therapeutic products for the treatment of flatfoot appeared in the market, for instance, corrective shoes.

However, the flatfoot corrective shoes in the market are very expensive, and the user will feel uncomfortable when wearing the corrective shoes for a long time.

The present invention has arisen to mitigate and/or obviate the afore-described disadvantages.

### SUMMARY

One objective of the present invention is to provide a foot stimulating mat structure which is capable of massaging the foot, relieving pressure and correcting the flatfoot.

To achieve the above objects, a mat structure provided by the invention comprises: an anti-skid layer, a rigid layer, an elastic piece and a soft layer which are superimposed upon one another;

the anti-skid layer is made of anti-skid material;

the rigid layer is attached to one side of the anti-skid layer, one surface of the rigid layer has a wavy shape and includes at least one convex portion and at least one concave portion, a surface of the convex portion has an arc-shaped shape, and the concave portion is located between two said convex portions;

the elastic piece is a wavy piece having one surface attached to the surface of the rigid layer, and made of an elastically deformable material, a wavy shape of the elastic piece matches with a shape of the surface of the rigid layer, the elastic piece has a plurality of projections and recesses connected one another, the projections are attached to the surface of the convex portions, the recesses are located in the concave portions, and curves of the projections and the recesses are arc-shaped;

the soft layer has one surface attached to another surface of the elastic piece, such that the elastic piece is located between the soft layer and the rigid layer, and the material of the soft layer is softer than that of the rigid layer.

A mat structure for mounting a shoe body provided by the invention comprises: an anti-skid layer, a rigid layer, an elastic piece and a soft layer which are superimposed upon one another;

the anti-skid layer is made of anti-skid material;

the rigid layer is attached to one side of the anti-skid layer, one surface of the rigid layer has a wavy shape and includes at least one convex portion and at least one concave portion, a surface of the convex portion has an arc-shaped shape, and the concave portion is located between two said convex portions;

the elastic piece is a wavy piece having one surface attached to the surface of the rigid layer, and made of an elastically deformable material, a wavy shape of the elastic piece matches with a shape of the surface of the rigid layer, the elastic piece has a plurality of projections and recesses connected one another, the projections are attached to the surface of the convex portions, the recesses are located in the concave portions, and curves of the projections and the recesses are arc-shaped;

the soft layer has one surface attached to another surface of the elastic piece, such that the elastic piece is located between the soft layer and the rigid layer, and the material of the soft layer is softer than that of the rigid layer.

As can be seen from the foregoing, with the characteristic of the elastic piece being elastically deformable, a rebounding force can be produced to act on the foot to stimulate the ligaments and muscles of the foot, which consequently corrects the flatfoot.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a cross sectional view of the mat structure in accordance with a preferred embodiment of the present invention;

FIG. 2 is an illustrative view showing that a user steps on the mat of the present invention; and

FIG. 3 is a partial cross sectional view of the sole structure of the invention.

### DETAILED DESCRIPTION

The present invention will be clearer from the following description when viewed together with the accompanying drawings, which show, for purpose of illustrations only, the preferred embodiment in accordance with the present invention.

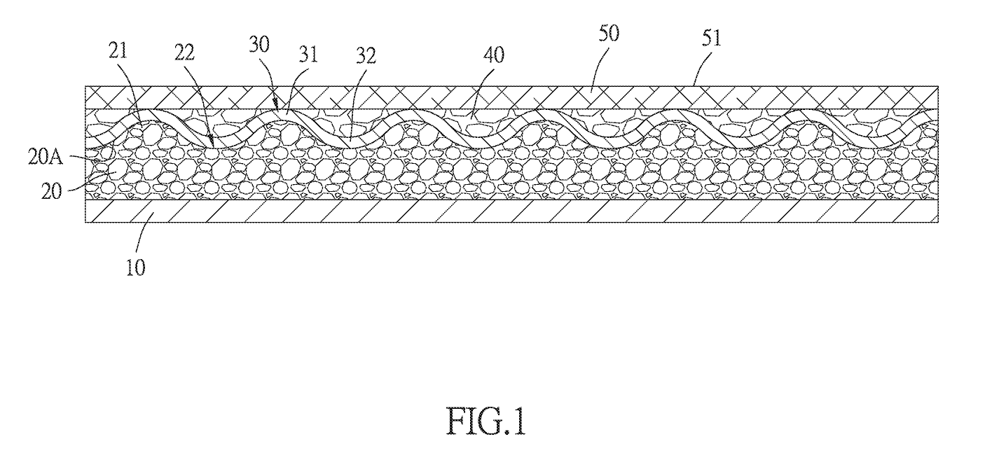

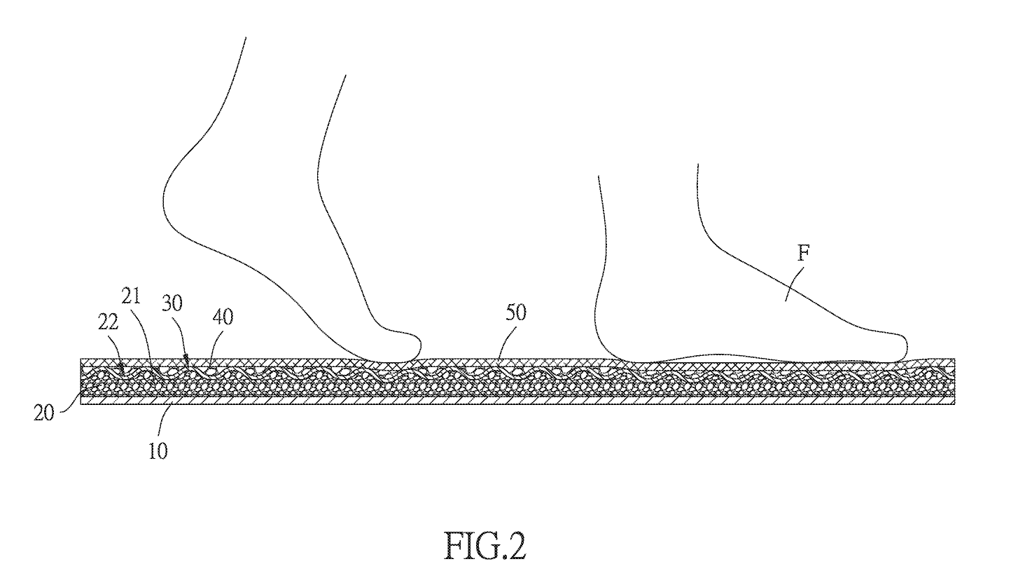

Referring to FIGS. 1-2, a mat structure in accordance with the present invention comprises: an anti-skid layer 10, a rigid layer 20, an elastic piece 30, a soft layer 40 which are superimposed upon one another.

The anti-skid layer 10 is made of anti-skid material which can be PVC and rubber.

The rigid layer 20 is attached to one side of the anti-skid layer 10, one surface 20A of the rigid layer 20 has a wavy shape which is close to a sine wave type. The rigid layer 20 includes at least one convex portion 21 and at least one concave portion 22. The convex portion 21 is a protruding portion, and the surface 20A of the convex portion 21 has an arc-shaped shape for stimulating the foot of the user, and the concave portion 22 is located between the two convex portions 21.

The elastic piece 30 is a wavy piece having one surface attached to the surface 20A of the rigid layer 20, and made of an elastically deformable material, such as a metal sheet made of aluminum or titanium, or a sheet made of other materials which are elastically deformed after being subjected to a force, such as a soft thermoplastic or the like. The wavy shape of the elastic piece 30 matches with the shape of the surface 20A of the rigid layer 20 such that the elastic piece 30 has a plurality of projections 31 and recesses 32 connected one another, the projections 31 are attached to the surface 20A of the convex portions 21, the recesses 32 are located in the concave portions 22, and the curves of the projections 31 and the recesses 32 is arc-shaped.

The soft layer 40 has one surface attached to another surface of the elastic piece 30, such that the elastic piece 30 is located between the soft layer 40 and the rigid layer 20. The material of the soft layer 40 is softer than the material of the rigid layer 20. Preferably, the soft layer 40 fills the recesses 32 and can be made of materials such as ethylene-vinyl acetate copolymer (EVA), chemically crosslinked polyethylene foaming material (XPE), expandable polyethylene (EPE Expandable Polyethylene), and polyvinyl chloride (PVC).

A preferred embodiment can further include a simulation layer 50 having one surface attached to another surface of the soft layer 40, and another surface of the simulation layer 50 is a simulation surface 51 which can simulate the touch of beach, grassland and rocky land.

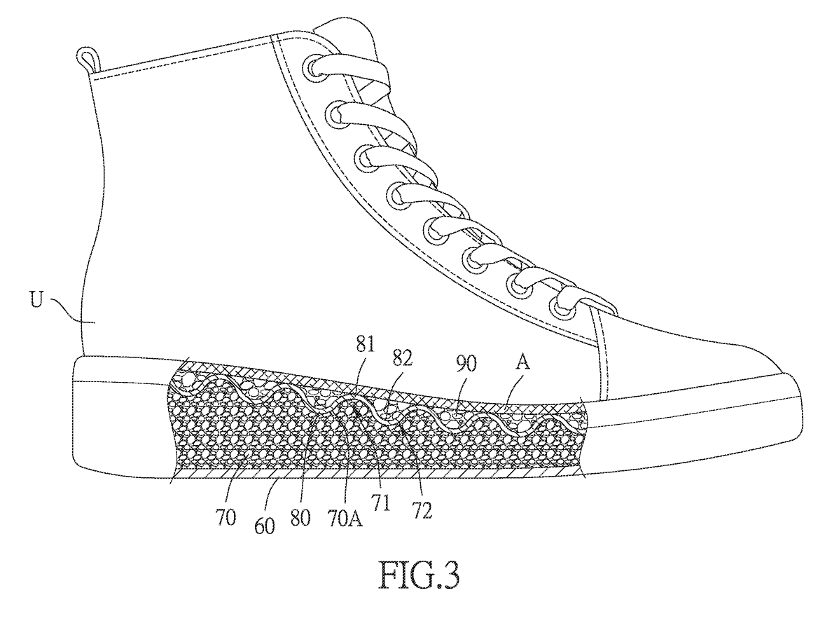

A sole structure for mounting on a shoe body U, please refer to FIG. 3, and the sole structure includes: an anti-skid layer 60, a rigid layer 70, an elastic piece 80, a soft layer 90 which are superimposed upon one another.

The anti-skid layer 60 is made of anti-skid material which can be PVC and rubber.

The rigid layer 70 is attached to one side of the anti-skid layer 60, one surface 70A of the rigid layer 70 has a wavy shape which is close to a sine wave type. The rigid layer 70 includes at least one convex portion 71 and at least one concave portion 72. The convex portion 71 is a protruding portion, and the surface 70A of the convex portion 71 has an arc-shaped shape for stimulating the foot of the user, and the concave portion 72 is located between the two convex portions 71.

The elastic piece 80 is a wavy piece having one surface attached to the surface 70A of the rigid layer 70, and made of an elastically deformable material, such as a metal sheet made of aluminum or titanium, or a sheet made of other materials which are elastically deformed after being subjected to a force, such as a soft thermoplastic or the like. The wavy shape of the elastic piece 80 matches with the shape of the surface 70A of the rigid layer 70 such that the elastic piece 80 has a plurality of projections 81 and recesses 82 connected one another, the projections 81 are attached to the surface 70A of the convex portions 71, the recesses 82 are located in the concave portions 72, and the curves of the projections 81 and the recesses 82 are arc-shaped.

The soft layer 90 has one surface attached to another surface of the elastic piece 80, such that the elastic piece 80 is located between the soft layer 90 and the rigid layer 70. The material of the soft layer 90 is softer than the material of the rigid layer 70. Preferably, the soft layer 90 fills the recesses 82 and can be made of materials such as ethylene-vinyl acetate copolymer (EVA), chemically crosslinked polyethylene foaming material (XPE), expandable polyethylene (EPE Expandable Polyethylene), and polyvinyl chloride (PVC).

A preferred embodiment can further include an insole layer A attached to another surface of the soft layer 90.

What mentioned above are the structural relations of the main components, and for the operation and function of the embodiment, reference should be made to FIG. 1-3.

When a user steps on the mat structure or the sole structure of the present invention, a load is provided on the elastic pieces 30, 80 to cause deformation of the elastic pieces 30, 80. When the stress of the foot F disappears, the elastic pieces 30, 80 will restore the original shape to provide the foot F a rebounding force to stimulate the ligaments and muscles of the foot F, thereby achieving the purpose of correcting the flat foot.

In addition, although the rigid layers 20 and 70 are harder than the soft layers 40 and 90, the rigid layers 20 and 70 will still deform to a certain extent when subjected to a force, thereby providing the foot F a reaction force in a timely manner, which can also give the elastic pieces 30, 80 margin of deformation.

It is worth mentioning that, since the shape of the rigid layers 20, 70 are wavy, and the material of the soft layers 40, 90 is softer than the material of the rigid layers 20, 70, so when walking on the mat or the sole, the user can receive the stimulating generated by the arch deformation and height change of the convex portions 21, 71 and the concave portions 22, 72, which consequently boosts the strength of the ligament and muscle of the foot. Besides, acupuncture points of the foot F can also be stimulated to effectively improve blood circulation.

In addition, the novel sole structure of the invention can mainly give the foot F different position stimulations every time the user steps out. In detail, since the center of gravity will be shifted from the heel to the front of the foot, when the user is walking. During the gravity shifting, the sole structure is given stress at different positions, and when the elastic pieces 30, 80 of the sole structure elastically restore shape, the rebounding force can give the foot F considerable stimulation, and then massage the feet and relieve stress.

While we have shown and described various embodiments in accordance with the present invention, it is clear to those skilled in the art that further embodiments may be made without departing from the scope of the present invention.

What is claimed is:

1. A mat structure, comprising: an anti-skid layer, a rigid layer, an elastic piece and a soft layer which are superimposed upon one another;
the anti-skid layer being made of anti-skid material;
the rigid layer being attached to one side of the anti-skid layer, one surface of the rigid layer having a wavy shape and including at least one convex portion and at least one concave portion, a surface of the convex portion has an arc-shaped shape, and the concave portion being located between two said convex portions;
the elastic piece is a wavy piece having one surface attached to the surface of the rigid layer, and made of an elastically deformable material, a wavy shape of the elastic piece matching with a shape of the surface of the rigid layer, the elastic piece having a plurality of projections and recesses connected one another, the projections are attached to the surface of the convex portions, the recesses are located in the concave portions, and curves of the projections and the recesses are arc-shaped;
the soft layer having one surface attached to another surface of the elastic piece, such that the elastic piece is located between the soft layer and the rigid layer, and the material of the soft layer is softer than that of the rigid layer.

2. The mat structure as claimed in claim 1 further comprising a simulation layer having one surface attached to another surface of the soft layer, and another surface of the simulation layer is a simulation surface.

3. The mat structure as claimed in claim 1, wherein the anti-skid material is PVC or rubber.

4. The mat structure as claimed in claim 1, wherein the soft layer fills the recesses.

5. A sole structure for mounting on a shoe body, comprising an anti-skid layer, a rigid layer, an elastic piece and a soft layer which are superimposed upon one another;
the anti-skid layer being made of anti-skid material;
the rigid layer being attached to one side of the anti-skid layer, one surface of the rigid layer having a wavy shape and including at least one convex portion and at least one concave portion, a surface of the convex portion has an arc-shaped shape, and the concave portion being located between two said convex portions;
the elastic piece is a wavy piece having one surface attached to the surface of the rigid layer, and made of an elastically deformable material, a wavy shape of the elastic piece matching with a shape of the surface of the rigid layer, the elastic piece having a plurality of projections and recesses connected one another, the projections are attached to the surface of the convex portions, the recesses are located in the concave portions, and curves of the projections and the recesses are arc-shaped;
the soft layer having one surface attached to another surface of the elastic piece, such that the elastic piece is located between the soft layer and the rigid layer, and the material of the soft layer is softer than that of the rigid layer.

6. The sole structure as claimed in claim 5 further comprising an insole layer attached to another surface of the soft layer.

7. The sole structure as claimed in claim 5, wherein the anti-skid material is PVC or rubber.

8. The sole structure as claimed in claim 5, wherein the soft layer fills the recesses.
